(19) United States
(12) Patent Application Publication
(10) Pub. No.: US 2012/0109664 A1
(43) Pub. Date: May 3, 2012

(54) OPTIMIZED CUSTOMER TARGETING BASED ON TEMPLATE CRM OFFERS

(75) Inventors: Raghuram Krishnapuram, New Delhi (IN); Sumit Negi, New Delhi (IN); Deepak S. Padmanabhan, Kerala (IN); Karthik Visweswariah, Bangalore (IN)

(73) Assignee: IBM CORPORATION, Armonk, NY (US)

(21) Appl. No.: 12/916,665

(22) Filed: Nov. 1, 2010

(51) Int. Cl. G06Q 30/00

(52) U.S. Cl. 705/1.1

(57) ABSTRACT

A Customer Relationship Management (CRM) offer template is established in data storage and includes at least one variable field and having at least one offer attribute. For each of a plurality of customer groups, a data processing system calculates an expected benefit to be obtained by sending an instantiated CRM offer to a customer based upon historical responses, offer cost, and legal values of the at least one variable field. The data processing system outputs a CRM offer instance and target list of customers that maximizes the expected benefit.

### BACKGROUND OF THE INVENTION

1. Technical Field

The present invention relates in general to data processing, and in particular, to optimized customer targeting based on template CRM offers.

2. Description of the Related Art

Customer relationship management (CRM) is the strategic application of technology to automate various customer-facing activities of an organization, including marketing, sales and customer service. Ultimately, an organization deploys CRM in its technology infrastructure or utilizes an outside CRM service provider in order to efficiently identify and attract new customers, retain and enhance the value of relationships with existing customers, thus driving increased sales of the organization's goods and services. CRM solutions, while automating some marketing functionality, can still require a significant amount of human intelligence to be applied in order to determine the targets and contents of future marketing campaigns.

### SUMMARY OF THE INVENTION

In some embodiments, a Customer Relationship Management (CRM) offer template is established in data storage and includes at least one variable field and having at least one offer attribute. For each of a plurality of customer groups, a data processing system calculates an expected benefit to be obtained by sending an instantiated CRM offer to a customer based upon historical responses, offer cost, and legal values of the at least one variable field. The data processing system outputs a CRM offer instance and target list of customers that maximizes the expected benefit.

### BRIEF DESCRIPTION OF THE DRAWINGS

FIG. 1 is a high level block diagram of a data processing environment in accordance with one embodiment;

FIG. 2 depicts an exemplary customer database in accordance with one embodiment;

FIG. 3 illustrates an exemplary CRM offer history in accordance with one embodiment;

FIG. 4 is a high level logical flowchart of an exemplary method of generating a CRM offer instance and associated target list; and

FIG. 5 depicts an exemplary CRM offer template in accordance with one embodiment.

### DETAILED DESCRIPTION OF ILLUSTRATIVE EMBODIMENT

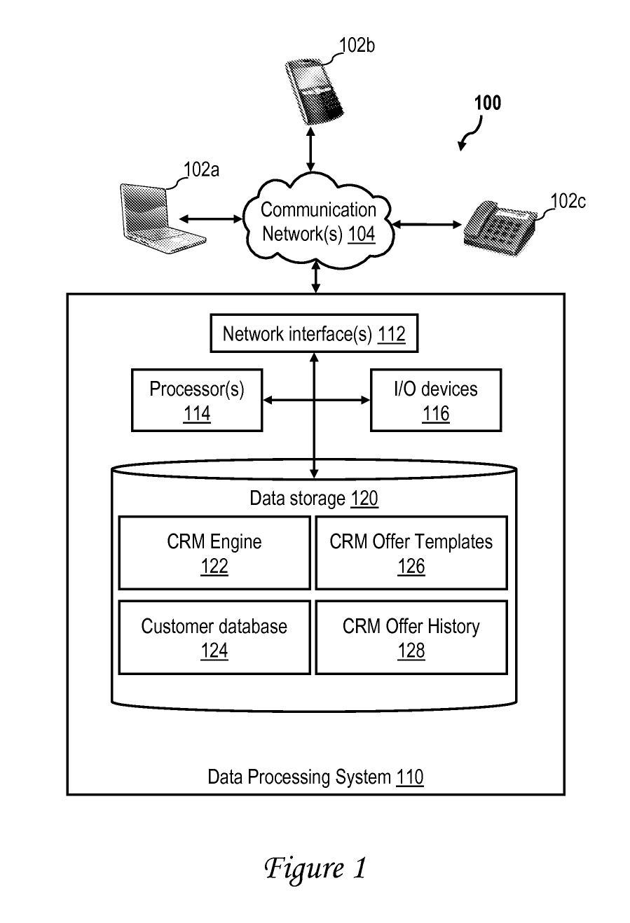

With reference now to the figures and with particular reference to FIG. 1, there is illustrated a high level block diagram of an exemplary data processing environment 100 in accordance with one embodiment. As shown, exemplary data processing environment 100 includes a data processing system 110, which can be operated or on behalf of an organization, such as a business, governmental agency, non-profit association, educational institution or the like, that engages in marketing. Data processing system 110 is coupled for communication to one or more circuit-switched or packet-switched communication networks 104, such as wired or wireless local area or wide area network(s), cellular telephony network(s), and/or public switched telephone network(s) (PSTNs). Thus, data processing system 110 may communicate with devices 102a-102c (e.g., computer systems, mobile telephones, smart phones, landline telephones) via communication network(s) 104.

The communication between devices 102-102c and data processing system 110 can include voice communication, for example, via a PSTN or voice over Internet Protocol (VoIP) connection, and/or data communication, for example, via instant messaging, Simple Mail Transport Protocol (SMTP) or Hypertext Transfer Protocol (HTTP). As described in greater detail below, the communication between data processing system 110 and devices 102 can include the transmission of marketing offers from data processing system 110 to devices 102 and the transmission of marketing responses from devices 102 to data processing system 110.

Still referring to FIG. 1, data processing system 110, which can include one or more physical computer systems, includes one or more network interfaces 112 that permit data processing system 110 to communicate via communication networks 104. Data processing system 110 additionally includes one or more processors 114 that execute program code, for example, in order to determine the targets and contents of marketing offers. Data processing system 110 also includes input/output (I/O) devices 116, such as ports, displays, and attached devices, etc., which receive inputs and provide outputs of the processing performed by data processing system 110. Finally, data processing system 110 includes data storage 120, which may include one or more volatile or non-volatile storage devices, including memories, optical or magnetic disk drives, tape drives, etc.

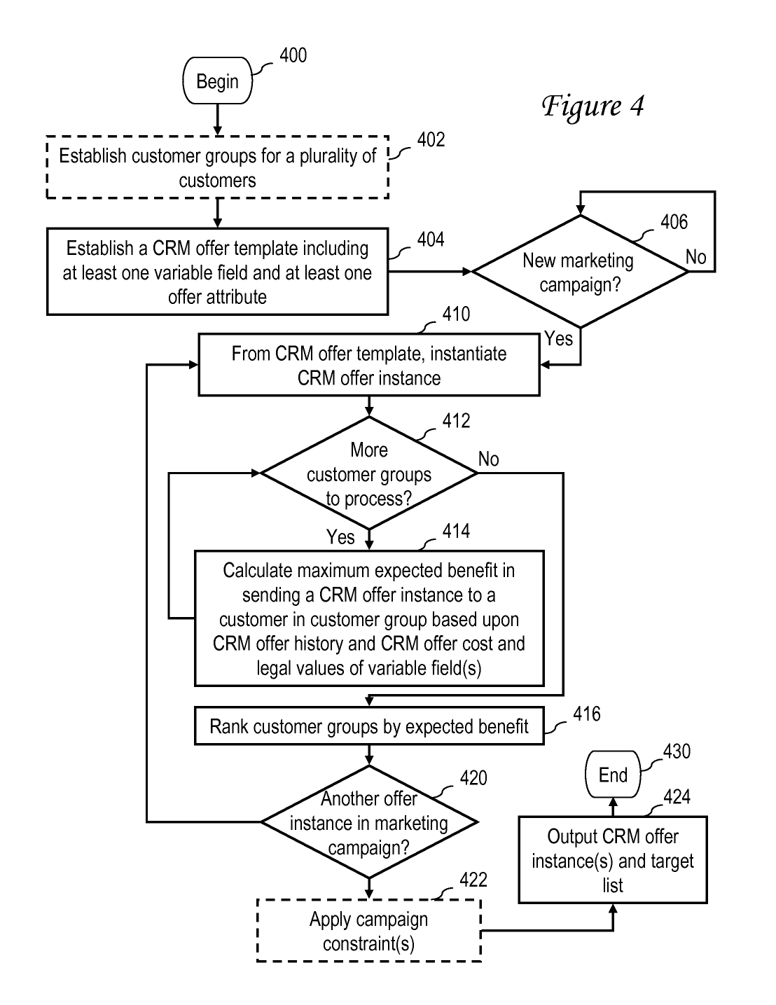

Data storage 120 stores data and program code, which can be processed and/or executed to implement customer relationship management (CRM) for an organization. In the depicted embodiment, the data and program code stored by data storage 120 includes CRM engine 122, which provides an interface through which personnel in the organization can record, update, view, manipulate, correlate and take action on customer-related marketing, sales and support data. Some of the marketing functions of CRM engine 122 are described below with reference to FIGS. 3-4.

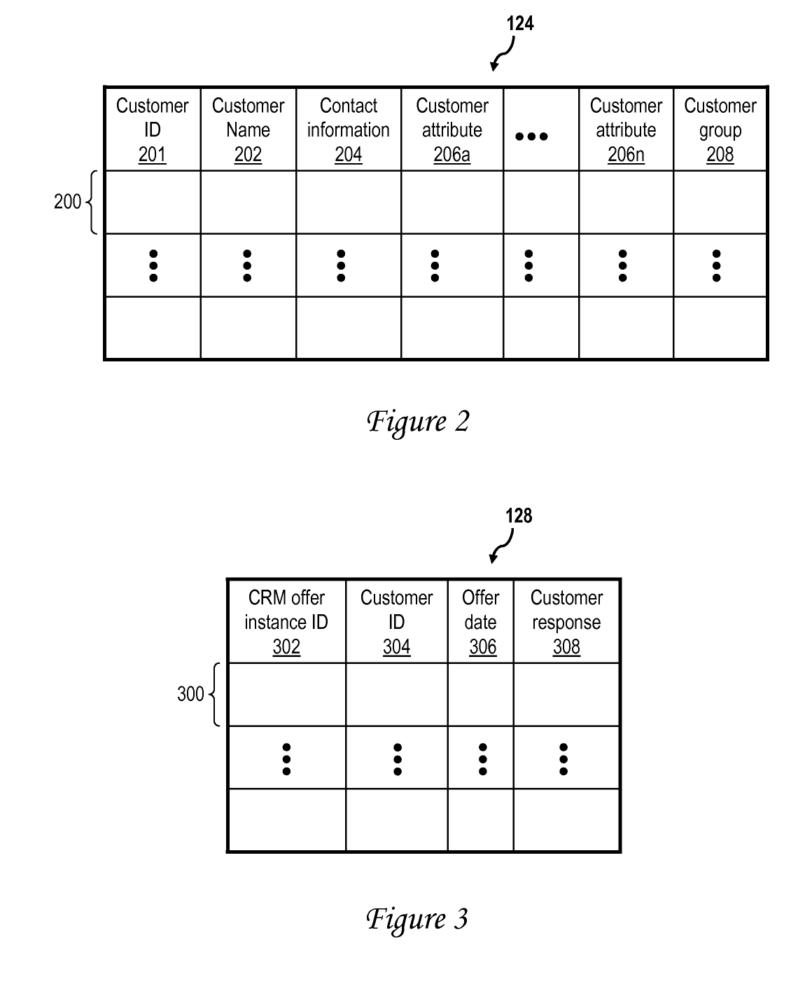

Data storage 120 additionally includes customer database 124, which records information regarding potential, current and/or former customers of the organization. As shown in FIG. 2, which depicts an exemplary embodiment of customer database 124, customer database 124 can include a plurality of customer records 200 each corresponding to a respective potential, current, or former customer of the organization. In the exemplary embodiment, each customer record 200 includes multiple fields, including a customer identifier (ID) field 201 that stores an ID assigned to the customer, a customer name field 202 that stores the name of the customer, and one or more contact information fields 204 that store contact information for the customer, such as phone number, email address, screen name, web site address, physical postal address, etc. Customer record 200 may include additional customer attribute fields 206a-206n that store customer attributes, such as demographic data, date of first purchase, date of last purchase, and products/services previously purchased. For human customers, the demographic data can include, for example, age, gender, marital status, income bracket, etc. For a business or other organization, the demographic data can include the corporate form of the organization, years in business, number of employees, industry, annual revenues, etc. Customer record 200 can additionally include customer group field 208, which identifies one or more customer groups to which the customer belongs for marketing purposes.

Returning to FIG. 1, data storage 120 additionally includes CRM offer templates 126, which include one or more (and preferably a plurality of) templates of marketing offers that can be instantiated in a marketing campaign. It should be appreciated that CRM offer templates 126 can include a number of diverse CRM offer templates for various products/services and/or can include similar CRM offer templates formatted for different delivery options (e.g., print, email, voice, HTML, etc.).

Data storage 120 further includes CRM offer history 128, which records data concerning previously used marketing offer instances. In the exemplary embodiment of CRM offer history 128 shown in FIG. 3, CRM offer history 128 includes a plurality of offer history records 300, each including multiple fields. These fields includes a CRM Offer Instance ID field 302 that identifies a CRM marketing offer instance by its unique ID, a customer ID field 304 that uniquely identifies a customer that received the CRM marketing offer instance, an offer date field 306 recording when the CRM marketing offer instance was transmitted to the customer, and a customer response field 308 indicating the customer's response to the CRM marketing offer instance. CRM offer history 128 may, of course, include additional information regarding a CRM marketing offer instance, for example, the number of units of the CRM marketing offer instance that were delivered in each format, the overall or per unit cost of the CRM marketing offer instance, and one or more success metrics (e.g., new customers, repeat customers, sales revenue, conversion rate, etc.).

It will be appreciated upon review of the foregoing description, the form in which data processing system 110 is realized can vary between embodiments based upon one or more factors, for example, the type of organization, the type and number of products/services offered by the organization, the type and number of customers of the organization, and the type and number of formats of CRM marketing offers that are employed. All such implementations, which may include, for example, one or more handheld, notebook, desktop, or server computer systems, are contemplated as embodiments of the inventions set forth in the appended claims.

Referring now to FIG. 4, there is depicted a high level logical flowchart of an exemplary process for generating a data-driven marketing offer in accordance with one embodiment. The depicted process may be performed, for example, through the execution of CRM engine 122 by a processor 114 of data processing system 110 of FIG. 1. As a logical flowchart, it should be understood that FIG. 4 presents various steps in the process in logical rather than chronological order. Accordingly, in various implementations, one or more of the illustrated steps can be performed in an alternative order or contemporaneously.

The process begins at block 400 and the proceeds to block 402, which depicts CRM engine 122 optionally establishing customer groups for a plurality of customers of an organization on behalf of which an instance of a CRM marketing offer is to be generated. For example, in one embodiment, CRM engine 122 places customers in groups based upon one or more of the customer attributes recorded within customer attribute fields 206a-206n of customer database 124. Depending on configuration or implementation, CRM engine 122 can establish the customer groups automatically or in response to user input. It should be appreciated that CRM engine 122 can selectively restrict group membership so that all customers are limited to membership in a maximum number of groups (e.g., a single group or five groups) and/or all customer groups have a predetermined minimum number of members. As noted previously, CRM engine 122 records group membership of customers, if any, in customer group field 208 of customer database 124.

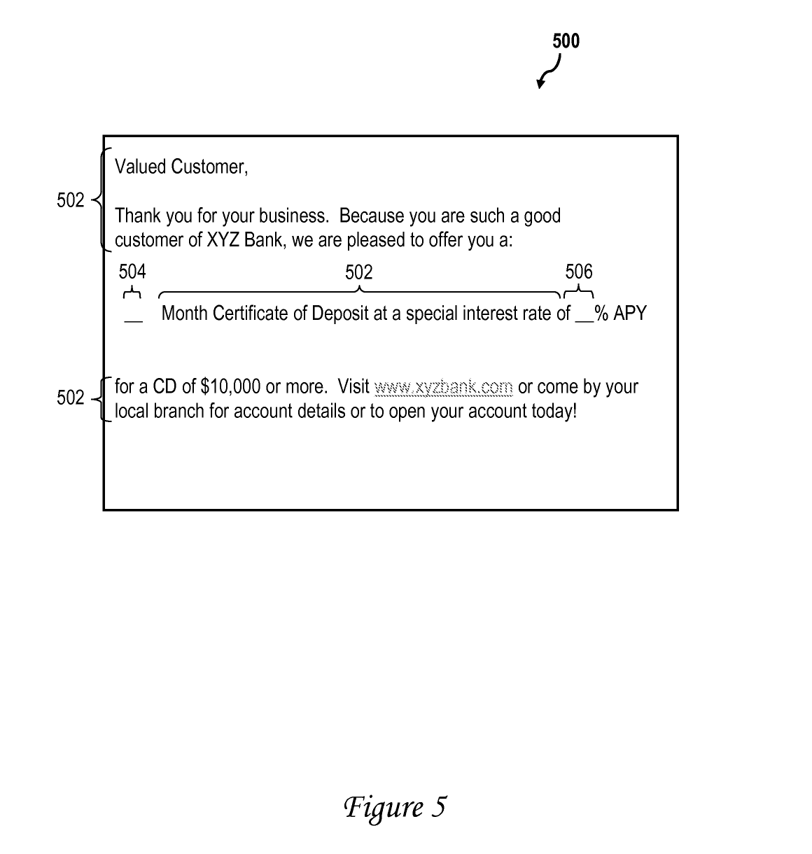

At block 404 of FIG. 4, CRM engine 122 establishes one or more (and preferably a plurality of) CRM offer templates 126, each including at least one variable field and having at least one associated offer attribute. Referring now to FIG. 5, there is illustrated an exemplary embodiment of a CRM offer template 500 within CRM offer templates 126 that is suitable for use on behalf of a financial institution (e.g., XYZ Bank). CRM offer template 500 includes fixed elements 502, which can include text, audio, video, graphics, code and/or other data common to all instances of CRM offer template 500. In the present example, fixed elements 500 include text offering to establish a Certificate of Deposit (CD) account for the customer. In addition, CRM offer template 500 includes two variable fields 504 and 506, which in the present example respectively define the duration of the CD and the interest rate. As will be appreciated, the number of variable fields can be fewer or greater in various implementations. Each variable field preferably has a predefined range of valid values that can be included in an instance of that CRM offer template. For example, CRM offer template 500 may define a duration range of 12-24 months for variable field 504 and an interest rate range of 2.5-4.375% for variable field 506.

CRM engine 122 further associates CRM offer template 500 with one or more offer attributes, such as “direct deposit” and “checking account.” Although in some cases the offer attributes may directly relate to the contents of the CRM offer template, in the case of CRM offer template 500 these offer attributes do not directly describe the contents of CRM offer template 500, but instead describe attributes of one or more other financial accounts of customers to whom an instance of CRM offer template 500 is to be sent.

Referring again to FIG. 4, CRM engine 122 determines at block 406 whether to initiate a new marketing campaign, for example, in response to a user input, automatically based upon a predetermined schedule of marketing campaigns, and/or in response to a determination that revenue and/or sales targets of the organization have crossed an upper or lower threshold. If at block 406 CRM engine 122 determines not to initiate a new marketing campaign, then the process iterates at block 406. If, however, CRM 122 determines to initiate a new marketing campaign at block 406, the process passes from block 406 to block 410.

Block 410 depicts CRM engine 122 instantiating a CRM offer instance (e.g., an instance of CRM offer template 500 of FIG. 5) within the new marketing campaign. The CRM offer template 126 to be used to instantiate the offer can be selected, for example, in response to a user input or automatically by CRM engine 122 based upon one or more factors, such as frequency of use, recency of use, and/or customer response to instances the CRM offer template 126 in previous marketing campaigns (as indicated by CRM offer history 128). As represented by blocks 412-414, CRM engine 122 then processes each of a plurality of customer groups (and in some embodiments all customer groups) with respect to the newly instantiated CRM offer instance. In particular, at block 414, CRM engine 122 calculates the maximum expected benefit to the organization for sending the CRM offer instance to a customer in the present customer group based upon CRM offer history 128, the cost of delivering the CRM offer instance, and the legal values of the variable field(s) in the CRM offer instance.

For example, consider a CRM offer instance 0 having a single variable field V that can take values v1, v2, . . . , vn. If a CRM offer instance is thus denoted as O[vi], at block 414 CRM engine 122 computes P(G,C[vi]), where P represents the fraction of positive responses recorded in CRM offer history 128 when customers in current customer group G were sent O[vi]. Of course, if the CRM offer instance includes multiple variable fields, fraction of positive responses P can be determined by applying a mathematical function to combine probabilities associated with the multiple variable fields. For example, P can be determined for a CRM offer instance including multiple variable fields by either summing or multiplying p(G,C[vi]) determined for each variable field individually, depending upon whether the variable fields are independent (in which case, the probabilities for the individual variable fields are summed) or dependent (in which case, the probabilities are multiplied).

CRM engine 122 additionally computes C(O[vi]), which is the cost of delivering the offer instance O in one or more selected formats (e.g., print, email, voice, autodial, website advertising, text message, etc.), as well as B(C[vi]), which is the benefit attained when offer instance O[vi] is accepted by an individual customer. Accordingly, EXP(G,O[vi]), the expected benefit to the organization for making the offer to a customer in the current customer group G can be computed as follows:

EXP(G,O[vi])=P(G,O[vi])*B(O[vi])−C(O[vi])

where vi is selected from the set v1, v2, . . . , vn to maximize EXP(G,O[vi]).

Having determined the expected benefit of sending a CRM offer instance to each customer group as shown at blocks 412-414, CRM engine 122 ranks the customer groups as recipients of the offer instance in accordance with the expected benefit to be obtained by delivering the CRM offer instance (block 416). Next, at block 420, CRM engine 122 determines whether or not another CRM offer instance is to be included in the present marketing campaign, for example, in response to a user input, automatically based upon a predetermined or default number of CRM offer instances per marketing campaign, and/or in response to revenue or sales data of the organization. If CRM engine 122 determines at block 420 to include another CRM offer instance in the current marketing campaign, the process returns from block 420 to block 410 and following blocks, which represents CRM engine 122 instantiating a different CRM offer instance to be included in the marketing campaign from a different CRM offer template 126 and generating a ranked target list of customer groups for the additional CRM offer instance. The process continues to iterate until all CRM offer instances to be included in the current marketing campaign are generated from CRM offer templates 126.

In response to CRM engine 122 determining at block 420 that all CRM offer instances for the present marketing campaign have been generated, the process proceeds to optional block 422. Block 422 depicts CRM engine 122 applying any constraints for the marketing campaign. While any number of constraints can be defined, exemplary constraints that may be applied at block 422 are set forth below in Table I.

TABLE I

| Constraint | Description |
|---|---|
| Fairness | Maximize the number of customers receiving at least |
| | one offer from the current marketing compaign |
| Prerequisites | Eliminate customers not meeting a given prerequisite |
| | to receive the CRM offer instance(s) in the current |
| | marketing compaign |
| Cost | Eliminate customer groups and/or individual customers |
| | from ranked list of recipients of the CRM offer |
| | instance(s) until a cost target is reached |

CRM engine 122 then outputs the CRM offer instance(s) and a target list of customers to receive each of the CRM offer instance(s) comprising the new marketing campaign (block 424) in accordance with a user-specified or automatically determined schedule (e.g., at regular calendar intervals or based upon customer response). Outputting the CRM offer instance(s) and target list as depicted at block 424 can include, for example, storing the CRM offer instance(s) and target list in data storage 120, transmitting the CRM offer instance(s) and target list via communication network(s) 104 to a third party for delivery to the customers, and/or transmitting the CRM offer instance(s) via communication network(s) 104 directly to devices 102 of customers (e.g., via email, voice, autodial, instant messaging, chat, HTML, etc.).

As has been described, in at least some embodiments, a Customer Relationship Management (CRM) offer template is established in data storage and includes at least one variable field and having at least one offer attribute. For each of a plurality of customer groups, a data processing system calculates an expected benefit to be obtained by sending an instantiated CRM offer to a customer based upon historical responses, offer cost, and legal values of the at least one variable field. The data processing system outputs a CRM offer instance and target list of customers that maximizes the expected benefit.

While the present invention has been particularly shown as described with reference to one or more preferred embodiments, it will be understood by those skilled in the art that various changes in form and detail may be made therein without departing from the spirit and scope of the invention. For example, although aspects have been described with respect to a computer system executing program code that directs the functions of the present invention, it should be understood that present invention may alternatively be implemented as a program product including a tangible, non-transient data storage medium (e.g., an optical or magnetic disk or memory) storing program code that can be processed by a data processing system to perform the functions of the present invention.

What is claimed is:

1. A method of data processing, comprising:
establishing a Customer Relationship Management (CRM) offer template in data storage, the CRM offer template including a variable field and having an offer attribute;
for each of a plurality of customer groups, a data processing system calculating an expected benefit to be obtained by sending an instantiated CRM offer to a customer based upon historical responses, offer cost, and legal values of the at least one variable field; and
the data processing system outputting a CRM offer instance and target list of customers that maximizes the expected benefit.

2. The method of claim 1, wherein the calculating includes adjusting the benefit obtained by a positive response based upon the historical responses.

3. The method of claim 1, wherein:
the variable field is a first variable field;
the CRM offer template includes a second variable field; and
the adjusting includes applying a function to combine probabilities associated with the first and second variable fields.

4. The method of claim 1, wherein:
the CRM offer template is a first CRM offer template;
the establishing comprises establishing a plurality of CRM offer templates, said plurality of CRM offer templates including the first CRM offer template;
the outputting includes outputting a set of CRM offer templates for a marketing campaign, the set including the first CRM offer template and at least a second CRM offer template among the plurality of CRM offer templates.

5. The method of claim 1, the outputting including ranking the plurality of groups according to the expected benefit per customer.

6. The method of claim 1, and further comprising applying at least one constraint prior to the outputting by modifying a preliminary list of customers in accordance with the constraint.

7. A program product, comprising:
a computer-readable storage medium; and
program code within the computer-readable storage medium that, when executed by a computer, causes the computer to perform:
establishing a Customer Relationship Management (CRM) offer template in data storage, the CRM offer template including a variable field and having an offer attribute;
for each of a plurality of customer groups, a data processing system calculating an expected benefit to be obtained by sending an instantiated CRM offer to a customer based upon historical responses, offer cost, and legal values of the at least one variable field; and
the data processing system outputting a CRM offer instance and target list of customers that maximizes the expected benefit.

8. The program product of claim 7, wherein the calculating includes adjusting the benefit obtained by a positive response based upon the historical responses.

9. The program product of claim 7, wherein:
the variable field is a first variable field;
the CRM offer template includes a second variable field; and
the adjusting includes applying a function to combine probabilities associated with the first and second variable fields.

10. The program product of claim 7, wherein:
the CRM offer template is a first CRM offer template;
the establishing comprises establishing a plurality of CRM offer templates, said plurality of CRM offer templates including the first CRM offer template;
the outputting includes outputting a set of CRM offer templates for a marketing campaign, the set including the first CRM offer template and at least a second CRM offer template among the plurality of CRM offer templates.

11. The program product of claim 7, the outputting including ranking the plurality of groups according to the expected benefit per customer.

12. The program product of claim 7, and further comprising applying at least one constraint prior to the outputting by modifying a preliminary list of customers in accordance with the constraint.

13. A data processing system, comprising:
a processor;
data storage coupled to the processor; and
program code stored within the data storage that, when executed by the processor, causes the data processing system to perform:
establishing a Customer Relationship Management (CRM) offer template in data storage, the CRM offer template including a variable field and having an offer attribute;
for each of a plurality of customer groups, a data processing system calculating an expected benefit to be obtained by sending an instantiated CRM offer to a customer based upon historical responses, offer cost, and legal values of the at least one variable field; and
the data processing system outputting a CRM offer instance and target list of customers that maximizes the expected benefit.

14. The data processing system of claim 13, wherein the calculating includes adjusting the benefit obtained by a positive response based upon the historical responses.

15. The data processing system of claim 13, wherein:
the variable field is a first variable field;
the CRM offer template includes a second variable field; and
the adjusting includes applying a function to combine probabilities associated with the first and second variable fields.

16. The data processing system of claim 13, wherein:
the CRM offer template is a first CRM offer template;
the establishing comprises establishing a plurality of CRM offer templates, said plurality of CRM offer templates including the first CRM offer template;
the outputting includes outputting a set of CRM offer templates for a marketing campaign, the set including the first CRM offer template and at least a second CRM offer template among the plurality of CRM offer templates.

17. The data processing system of claim 13, the outputting including ranking the plurality of groups according to the expected benefit per customer.

18. The data processing system of claim 13, and further comprising applying at least one constraint prior to the outputting by modifying a preliminary list of customers in accordance with the constraint.
